(19) United States
(12) Patent Application Publication
(10) Pub. No.: US 2013/0058527 A1
(43) Pub. Date: Mar. 7, 2013

(54) SENSOR DATA PROCESSING

(71) Applicant: Thierry Peynot, Potts Point (AU)

(72) Inventor: Thierry Peynot, Potts Point (AU)

(73) Assignee: The University of Sydney, Sydney (AU)

(21) Appl. No.: 13/583,456

(22) PCT Filed: Feb. 25, 2011
(86) PCT No.: PCT/AU2011/000205

§ 371 Date: Nov. 15, 2012

(30) Foreign Application Priority Data
Mar. 9, 2010 (AU) 201020875

(51) Int. Cl. G06K 9/62

(52) U.S. Cl. 382/103

(57) ABSTRACT

A method and apparatus for processing sensor data comprising measuring a value of a first parameter of a scene using a first sensor (e.g. a camera) to produce a first image of the scene, measuring a value of a second parameter of the scene using a second sensor (e.g. a laser scanner) to produce a second image, identifying a first point of the first image that corresponds to a class of features of the scene, identifying a second point of the second image that corresponds to the class of features, projecting the second point onto the first image, determining a similarity value between the first point and the projection of the second point on to the first image, and comparing the determined similarity value to a predetermined threshold value. The method or apparatus may be used on an autonomous vehicle.

### FIELD OF THE INVENTION

The present invention relates to processing of sensor data. In particular, the present invention relates to the processing of data corresponding to respective images of a scene generated using two respective sensors.

### BACKGROUND

In the field of autonomous vehicles, the term “perception” relates to an autonomous vehicle obtaining information about its environment and current state through the use of various sensors.

Conventional perception systems tend to fail in a number of situations. In particular, conventional systems tend to fail in challenging environmental conditions, for example in environments where smoke or airborne dust is present. A typical problem that arises in such cases is that of a laser range finder tending to detect a dust cloud as much as it detects an obstacle. This results in conventional perception systems tending to identify the dust or smoke as an actual obstacle. Thus, the ability of an autonomous vehicle may be adversely affected because obstacles that are not present have been identified by the vehicle's perception system.

### SUMMARY OF THE INVENTION

In a first aspect, the present invention provides a method of processing sensor data, the method comprising measuring a value of a first parameter of a scene using a first sensor to produce a first image of the scene, measuring a value of a second parameter of the scene using a second sensor to produce a second image of the scene, identifying a first point, the first point being a point of the first image that corresponds to a class of features of the scene, identifying a second point, the second point being a point of the second image that corresponds to the class of features, projecting the second point onto the first image, determining a similarity value between the first point and the projection of the second point on to the first image, and comparing the determined similarity value to a predetermined threshold value.

The similarity value may be a value related to a distance in the first image between the first point and the projection of the second point on to the first image.

The method may further comprise defining a neighbourhood in the second image around the second point, and projecting the neighbourhood onto the first image, wherein the step of identifying the first point comprises identifying the first point such that the first point lies within the projection of the neighbourhood onto the first image.

The step of determining a value related to a distance may comprise defining a probability distribution mask over the projection of the neighbourhood in the first image, the probability distribution mask being centred on the projection of the second point on the first image, and determining a value of the probability distribution mask at the first point.

The first parameter may be different to the second parameter.

The first sensor may be a different type of sensor to the second sensor.

The first parameter may be light intensity, the first sensor type may be a camera, the second parameter may be range, and/or the second sensor type may be a laser scanner.

The method may further comprise calibrating the second image of the scene with respect to the first image of the scene.

The step of calibrating the second image of the scene with respect to the first image of the scene may comprise determining a transformation to project points in the second image to corresponding points in the first image.

A step of projecting may be performed using the determined transformation.

The similarity value may be a value of a probability that the second image corresponds to the first image.

The probability may be calculated using the following formula:

$$P ( A \vert B , C ) = η \frac{P ( C \vert A , B ) P ( B \vert A ) P ( A )}{P ( B )}$$

where: A is the event that the second image corresponds to the first image;
B is the event that the first point lies within the projection of the neighbourhood onto the first image;
C is the projection of the second point onto the first image; and
η is a normalisation factor.

In a further aspect, the present invention provides apparatus for processing sensor data, the apparatus comprising a first sensor for measuring a value of a first parameter of a scene to produce a first image of the scene, a second sensor for measuring a value of a second parameter of the scene to produce a second image of the scene, and one or more processors arranged to: identify a first point, the first point being a point of the first image that corresponds to a class of features of the scene, identify a second point, the second point being a point of the second image that corresponds to the class of features, project the second point onto the first image, determine a similarity value between the first point and the projection of the second point on to the first image, and compare the determined similarity value to a predetermined threshold value.

The similarity value may be a value related to a distance in the first image between the first point and the projection of the second point on to the first image.

In a further aspect, the present invention provides an autonomous vehicle comprising the apparatus of the above aspect.

In a further aspect, the present invention provides a computer program or plurality of computer programs arranged such that when executed by a computer system it/they cause the computer system to operate in accordance with the method of any of the above aspects.

In a further aspect, the present invention provides a machine readable storage medium storing a computer program or at least one of the plurality of computer programs according to the above aspect.

### BRIEF DESCRIPTION OF THE DRAWINGS

FIG. 1 is a schematic illustration (not to scale) of an example scenario in which an embodiment of a process for improving perception integrity is implemented; and

FIG. 2 is a process flow chart showing certain steps of an embodiment of the process for improving perception integrity.

### DETAILED DESCRIPTION

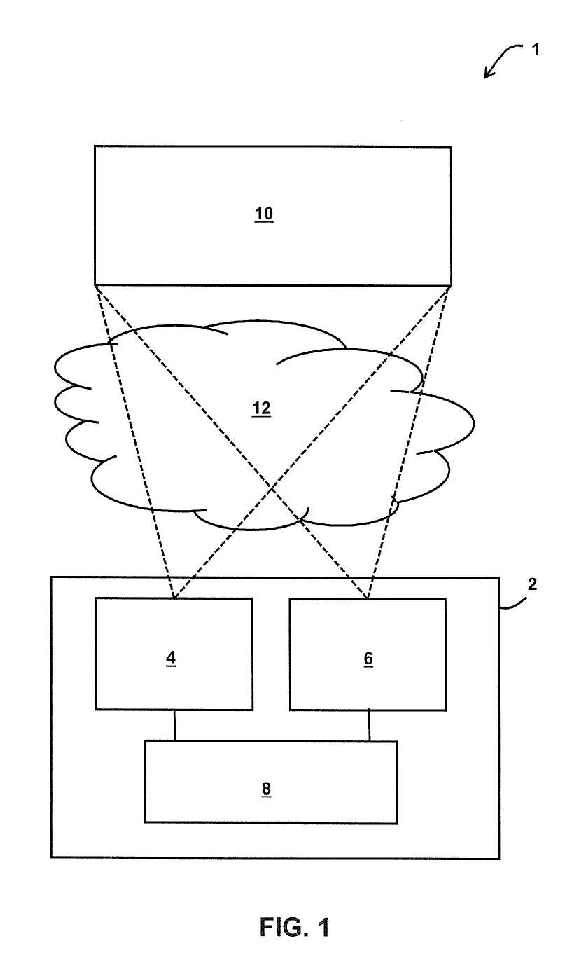

FIG. 1 is a schematic illustration (not to scale) of an example scenario 1 in which an embodiment of a process for improving perception integrity is implemented.

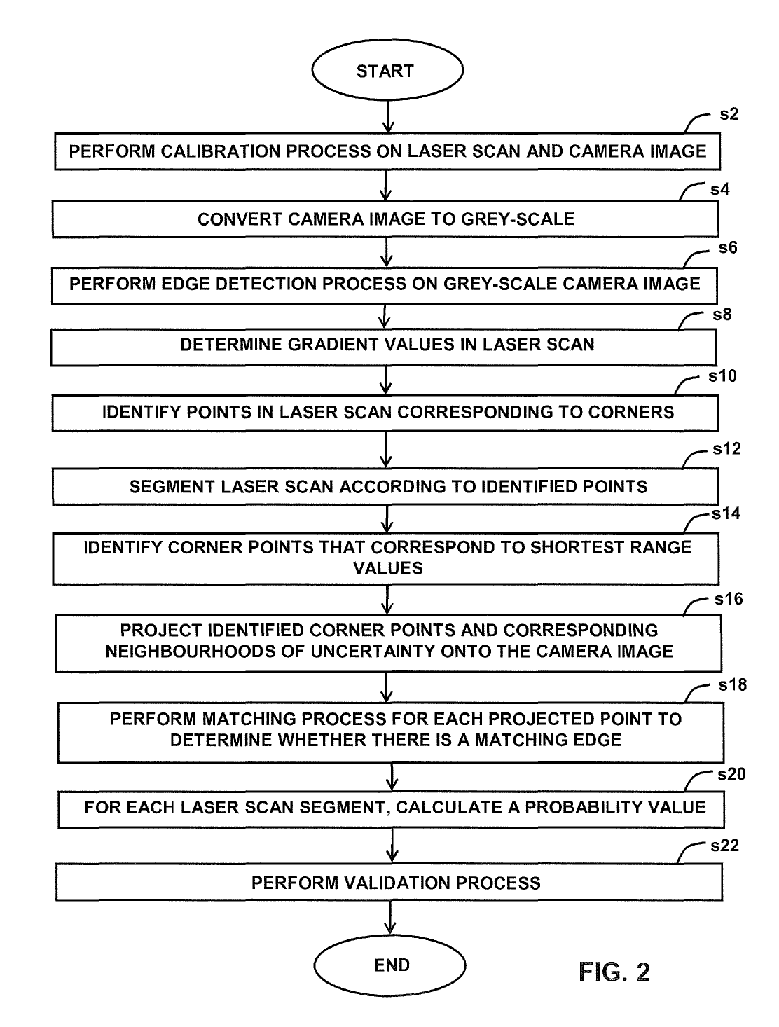

The terminology “perception” is used herein to refer to a process by which a vehicle's sensors are used to perform measurements of the vehicle's surroundings and process these measurements in order to enable the vehicle to successfully navigate through the surroundings. The process for improving perception integrity is described in more detail later below with reference to FIG. 2.

In the scenario 1, a vehicle 2 comprises a camera 4, a laser scanner 6 and a processor 8. The camera 4 and the laser scanner 6 are each coupled to the processor 8. The vehicle 2 is a land-based vehicle.

In the scenario 1, the vehicle 2 performs autonomous navigation within its surroundings. The vehicle's surroundings comprise a plurality of obstacles, which are represented in FIG. 1 by a single box and indicated by the reference numeral 10.

The autonomous navigation of the vehicle 2 is facilitated by measurements made by the vehicle 2 of the obstacles 10. These measurements are made using the camera 4 and the laser scanner 6.

The camera 4 takes light intensity measurements of the obstacles 10 from the vehicle. This intensity data (hereinafter referred to as “camera data”) is sent from the camera 4 to the processor 8. The camera data is, in effect, a visual image of the obstacles 10 and is hereinafter referred to as the “camera image”. The camera 4 is a conventional camera.

The laser scanner 6 takes range or bearing measurements of the obstacles 10 from the vehicle 2. This range data (hereinafter referred to as “laser data”) is sent from the laser scanner 6 to the processor 8. The laser data is, in effect, an image of the obstacles 10 and/or the dust cloud 12. This image is hereinafter referred to as the “laser scan”. The laser scanner 6 is a conventional laser scanner.

In this embodiment, the camera image and the laser scan are continuously acquired and time-stamped. However, in other embodiments, images and scans may be acquired on intermittent bases. Also, in other embodiments, time-stamping need not be employed, and instead any other suitable form of time-alignment or image/scan association may be used.

The use of the camera 4 and the laser scanner 6 to make measurements of the obstacles 10 is represented in FIG. 1 by sets of dotted lines between the camera 4 and the obstacles 10 and between the laser scanner 6 and the obstacles 10 respectively.

The camera image and the laser scan are processed by the processor 8 to enable the vehicle 2 to navigate within its surroundings. The processor 8 compares a laser scan to a camera image, the laser scan being the closest laser scan in time (e.g. based on the time-stamping) to the camera image, as described in more detail below.

In the scenario 1, the images of the obstacles 10 generated using the camera 4 and the laser scanner 6 are made through a dust cloud 12. In other words, the dust cloud 12 at least partially obscures the obstacles 10 from the camera 4 and/or laser scanner 6 on the vehicle. For the purpose of illustrating the present invention, it is assumed that the presence of the dust cloud 12 affects the measurements taken by the camera 4 and the laser scanner 6 to different degrees. In particular, the laser scanner 6 detects the dust cloud 12 the same as it would detect an obstacle, whereas the dust cloud 12 does not significantly affect the measurements of the obstacles 10 taken by the camera 4.

An embodiment of a process for improving perception integrity, i.e. improving the vehicle's perception of its surroundings (in particular, the obstacles 10) in the presence of the dust cloud 12, will now be described.

FIG. 2 is a process flow chart showing certain steps of an embodiment of the process for improving perception integrity.

It should be noted that certain of the process steps depicted in the flowchart of FIG. 2 and described above may be omitted or such process steps may be performed in differing order to that presented above and shown in FIG. 2. Furthermore, although all the process steps have, for convenience and ease of understanding, been depicted as discrete temporally-sequential steps, nevertheless some of the process steps may in fact be performed simultaneously or at least overlapping to some extent temporally.

At step s2, a calibration process is performed on the camera image and the laser scan to determine an estimate of the transformation between the laser frame and the camera frame. This transformation is hereinafter referred to as the “laser-camera transformation”. In this embodiment, this calibration process is a conventional process. For example, the camera may be calibrated using the camera calibration toolbox for Matlab™ developed by Bouget et al., and the estimate of the laser-camera transformation may be determined using a conventional technique.

This step provides that every laser point whose projection under the laser-camera transformation belongs to the camera image may be projected onto the camera image.

Steps s4 to s20, described below, define a process by which a value that is indicative of how well the laser scan and the camera image correspond to each other (after the performance of the laser-camera transformation) is determined.

At step s4, the camera image is converted in to a gray-scale image. In this embodiment, this conversion is performed in a conventional manner.

At step s6, an edge detection process is performed on the gray-scale camera image.

In this embodiment, edge detection in the camera image is performed in a conventional manner using a Sobel filter. In this embodiment, the laser scanner 6 is arranged to scan the obstacles 10 in a plane that is substantially horizontal to a ground surface, i.e. scanning is performed in a plane substantially perpendicular to the image plane of the camera image. Thus, in this embodiment a filter for detecting vertical edges is used. In other embodiments, a different type of filter for detecting different edges may be used, for example a filter designed for detecting horizontal edges may be used in embodiments where the laser scanner is arranged to scan vertically.

In this embodiment, the filtered image is, in effect, the image that results from the convolution of the grey-scale image with the following mask:

$$[ \begin{matrix}1 & 0 & - 1 \\ 2 & 0 & - 2 \\ 1 & 0 & - 2\end{matrix} ]$$

In this embodiment, an edge in the camera image is indicated by a sudden variation in the intensity of the grey-scale camera image.

At step s8, gradient values for the range parameter measured by the laser scanner 6 are determined.

In this embodiment, the gradient values are obtained in a conventional way from the convolution of the laser scan with the following mask:

[−1/2 0 1/2]

At step s10, points in the laser scan that correspond to “corners” are identified.

The terminology “corner” is used herein to indicate a point at which there is a sudden variation of range along the scan. This may, for example, be caused by the laser scanner 6 measuring the range from the vehicle 2 to an obstacle 10. As the laser scanner 6 scans beyond the edge or corner of the obstacle 10, there is a sudden and possibly significant change in the range values measured by the laser scanner 6.

In this embodiment, points in the laser scan that correspond to a corner are those points that have a gradient value (determined at step s14) that has an absolute value that is greater than a first threshold value. This first threshold value is set to be above a noise floor.

In this embodiment, in many cases, two successive points of the laser scan correspond to corners, i.e. one laser point either side of the laser scan discontinuity. These form pairs of corners.

At step s12, the laser scan is segmented, i.e. a plurality of segments is defined over the laser scan. In this embodiment, a segment of the laser scan comprises all the points between two successive laser corner points.

At step s14, one of each of the two laser points (corners) of the pairs identified at step s10 is selected.

In this embodiment, of each of the pairs of laser points corresponding to successive corners, the laser point that corresponds to a shorter range is selected. This selected laser point is the most likely point of the pair to correspond to an edge in the camera image, after projection.

At step s16, the selected laser corner points are projected onto the camera image (using the laser-camera transformation). Also, respective pixel neighbourhoods of uncertainty corresponding to each of the respective projected points are computed.

In this embodiment, these neighbourhoods of uncertainty are determined in a conventional manner as follows.

Points in the laser scan are related to corresponding points in the camera image as follows:
where: Pₗ is a point in the laser scan;
P_{c} is a point in the camera image corresponding to the point Pₗ;

$$Δ = [ \begin{matrix}{δ}_{x} \\ {δ}_{y} \\ {δ}_{z}\end{matrix} ]$$

is a translation offset; and
Φ is a rotation matrix with Euler angles φₓ, φ_{y}, φ_{z}.

In this embodiment, the laser-camera calibration optimisation (described above at step s2) returns values for Δ and Φ by minimising the sum of the squares of the normal errors. The normal errors are simply the Euclidean distance of the laser points from the calibration plane in the camera image frame of reference.

In this embodiment, the uncertainty of the parameters Δ and Φ is found by implementing a method as described in “Approximate Tests of Correlation in Time-Series”, Quenouille M. H., 1949, Journal of the Royal Statistical Society, Vol. 11, which is incorporated herein by reference. What will now be described is certain aspects relating to ways in which this method may be applied to the above mentioned laser-camera calibration optimisation.

Let xᵢ represent the set of data points of the ith laser scan of the dataset.

So called “Jackknife” samples are taken from the dataset.
The ith Jackknife sample Xᵢ is simply all the data points except those of the ith laser scan, i.e.

Xᵢ={x₁, x₂, . . . , xᵢ₋₁, xᵢ₊₁, . . . , xₙ}.

Thus, n different Jackknife samples are produced.

Let pᵢ=[δₓ δ_{y} δ_{z} φₓ φ_{y} φ_{z}]ᵢ be the parameter vector obtained from running the optimisation on the ith Jackknife sample. The mean of the parameter vectors is given by

$$\hat{ρ} = \frac{{\sum }_{i} {ρ}_{i}}{n} .$$

The standard error of the parameters is therefore given by:

$${SE}_{ρ} = {[ \frac{n - 1}{n} {\sum }_{i = 1}^{n} {( {ρ}_{i} - \hat{ρ} )}^{2} ]}^{1 / 2} .$$

An uncertainty propagation method used in this embodiment employed is described in “Reliable and Safe Autonomy for Ground Vehicles in Unstructured Environments”, Underwood, J. P., Mechanical and Mechatronic Engineering, 2008, School of Aerospace, The University of Sydney, Sydney, which is incorporated herein by reference.

In other embodiments, a different technique of computing the neighbourhoods of uncertainty may be used. For example, a common ‘calibration object’ could be identified in the camera image and laser scan. An edge of this calibration object may then be used to generate a maximum error value, which can be used to define a neighbourhood of uncertainty.

The computed neighbourhoods of uncertainty corresponding to each of the respective projected points are also projected onto the camera image (using the laser-camera transformation).

A selected laser corner point, and a respective neighbourhood of uncertainty that surrounds that laser point, each have a projected image on the camera image under the laser-camera transformation. The projection of a laser corner point is, a priori, a best estimate of the pixel of the camera image that corresponds to that laser point. The projection of a neighbourhood surrounds the projection of the corresponding laser corner point.

At step s18, for each laser corner point projected on to the camera image at step s16, it is determined whether there is a matching edge in the camera image within the projection of the neighbourhood of uncertainty of that laser point. In this embodiment, the terminology “matching edge in the camera image” refers to at least two points (pixels) in the camera image, in two different consecutive lines and connected columns of the relevant neighbourhood of uncertainty, having a Sobel intensity greater than a predefined second threshold value.

The matching process of step s18 comprises identifying a camera image edge within a neighbourhood of a projection of a laser corner point. In other words, the matching process comprises identifying points in the camera image within a projection of a neighbourhood, the points having an intensity value greater than the second threshold value.

At step s20, for each projected laser point, a probability that the laser information corresponds to the information in the camera image acquired at the same time is estimated.

In this embodiment, the probability of correspondence between the laser and camera image, for a certain projected laser point corresponding to a selected corner, is determined using the following formula:

$$P ( A \vert B , C ) = \frac{P ( C \vert A , B ) P ( B \vert A ) P ( A )}{P ( C \vert B ) P ( B )}$$

where: A is the event that the laser and camera information correspond;
B is the event that an edge is found in the projection of the neighbourhood of the certain projected laser point;
C is the projection on to the camera image of this certain projected laser point; and
η is a normalisation factor.

Thus, the terms in the above equation have the following definitions:

P(A|B,C) is the probability that, for a given laser corner point, the laser and camera information correspond given the projection of that laser corner point and given that an edge was found in the projection of the neighbourhood of that projected laser corner point;

P(C|A,B) is the probability of the certain laser data projection on the camera image, given that the laser and camera data correspond, and given that a visual edge was found in the projection of the neighbourhood of the certain laser point projection. This term is directly related to the uncertainty of the projection of the laser point on the image. In this embodiment, the value of this term is computed using a Gaussian mask over the neighbourhood of the certain projected laser point. This Gaussian represents the distribution of probability for the position of the laser projected point. In this embodiment, if a visual edge was found in the projection of the neighbourhood, then the value of the term P(C|A,B=1) is the value of the Gaussian mask at the closest pixel belonging to the visual edge. Also, if no visual edge was found in the projection of the neighbourhood, then the value of the term P(C|A,B=0) is the probability that the projection of the laser point is outside of the projection of the neighbourhood.

P(B|A) is the probability that a visual edge is found in the neighbourhood, given that the laser and camera information do correspond. This term describes the likelihood of the assumption that if the laser and camera information do correspond, then any laser corner should correspond to a visual edge in the camera image. In this embodiment, the value of this term is fixed and close to 1, i.e. knowing the laser and camera data do correspond, a visual edge usually exists.

P(A) is the a priori probability that the laser data and camera data correspond. In this embodiment, the value of this term is set to a fixed uncertain value. This represents the fact that, in this embodiment, there is no a priori knowledge on that event;

P(B) is the a priori probability of finding a visual edge. It is expressed as: P(B)=P(B|A)P(A)+P(B|Ā)P(Ā) with P(Ā)=1−P(A). In this embodiment, the value of the term P(B|Ā) is the probability of finding a visual edge anywhere in the camera image (using the process described at step s6 above); and

P(C|B)=P(C|B,A)P(A)+P(C|B,Ā)P(Ā), where only the term remains to be described is P(C|B,Ā). This term corresponds to the confidence on the projection of the laser point on to the image, knowing that the laser and camera data do not correspond (not A) and that an edge was found or not (B). If the data do not correspond, then the even B does not provide more information for C, thus we can say that P(C|B,Ā)=P(C|Ā). This term corresponds to the confidence in the calibration (i.e. quality of the projection). In this embodiment it is taken as the best chance for the projection, i.e. the probability read at the centre of the neighbourhood of uncertainty (in other words, the maximum probability in the neighbourhood).

Thus, in this embodiment the determined values of the probability that the laser information corresponds to the information in the camera image (for a certain projected laser point corresponding to a selected corner) are values related to a distance in the camera image between a camera edge and the projection of a corresponding laser corner on to the camera image. In other embodiments other similarity values, i.e. values encapsulating the similarity between the camera edge and the projection of a corresponding laser corner on to the camera image, may be used.

At step s22, a validation process is performed to validate the laser data relative to the camera data.

In this embodiment, the validation process comprises making a decision about whether each of the laser scan segments corresponds to the camera image data. In this embodiment, for a given laser scan segment, if the corners belonging to this segment have a matching edge in the camera image, i.e. the probabilities for those corners, determined at step s20, are greater than a predefined threshold (hereinafter referred to as the “third threshold value”), then the laser data of that segment is considered to correspond to the camera data, i.e. the laser data is validated and can be combined (or associated) with the camera image data. However, if the corners belonging to this segment have no matching edge in the image (i.e. the probabilities for those points are lower than the third threshold), then the laser data of the certain segment is considered to not correspond to the camera data. In this case, the data from both types of sensors is treated differently. In this embodiment, the laser data is considered as inconsistent with the camera data (i.e. it has been corrupted by the presence of the dust cloud 12). Therefore, fusion of laser data and camera data is not permitted for the purposes of navigation of the vehicle 2. In other embodiments, different validation processes may be used.

If it is determined that the laser scan and camera image correspond, the laser and camera data can be fused. The fused data is integrated with any other sensing data in a perception system of the vehicle 2. However, if it is determined that the laser and camera image do not correspond, only the most reliable of the data (in this embodiment the data corresponding to the camera image) is integrated with any other sensing data in a perception system of the vehicle 2. This advantageously avoids the utilising of non-robust data for the purposes of perception. Also, the above described method advantageously tends to provide better perception capabilities of the vehicle 2. In other words, the above described method advantageously tends to increase the integrity of a perception system of the vehicle 2.

An advantage of the above described method is that it tends to increase the integrity of a vehicle's perception capabilities in challenging environmental conditions, such as the presence of smoke or airborne dust. The increasing of the integrity of the vehicle's perception capabilities tends to enable the vehicle to navigate better within an environment.

The present invention advantageously compares data from laser scans and camera images to detect inconsistencies or discrepancies. In this embodiment, these discrepancies arise when the laser scanner 6 detects dust from the dust cloud 12. The effect of this dust tends to be less significant on the visual camera (or infrared) image, at least as long as the density of the dust cloud remains “reasonable”. The method is capable of advantageously identifying that there is a discrepancy between the laser data and the camera data, so that only the relatively unaffected camera data is used for the purposes of navigating the vehicle.

A further advantage of the present invention is that a process of comparing laser data (comprising range/bearing information) to camera image data (comprising measurements of intensity, or colour, distributed in space on the camera plane) tends to be provided. In this embodiment, common characteristics in the data, in particular geometrical characteristics, are compared to provide this advantage.

The present invention advantageously tends to exploit redundancies in the observations made by the laser scanner and the camera in order to identify features that correspond to each other in the laser scan and the camera image. Also, for each laser point that can be projected onto the camera image, an estimate of a likelihood that the sensing data provided by the laser does corresponds to the data in the image is advantageously provided. This allows a decision upon the veracity of the laser data compared to the camera data to be made.

A further advantage of the above embodiments is that the detection of discrepancies between laser data and camera data tends to be possible. Moreover, this tends to allow for the detection of misalignment errors, typically when the discrepancies/inconsistencies concern the whole laser scan.

In the above embodiments the vehicle is a land-based vehicle. However, in other embodiments the vehicle is a different type of vehicle, for example an aircraft.

In the above embodiments the vehicle performs autonomous navigation. However, in other embodiments navigation of the vehicle is not performed autonomously. For example, in other embodiments an embodiment of a method of improving the integrity of perception is used to support/advise a human navigator of a vehicle (e.g. a driver or a pilot) who may be on or remote from the vehicle.

In the above embodiments the vehicle comprises a laser scanner and a camera. However, in other embodiments the vehicle comprises any two different heterogeneous sensors, the data from which may be processed according to the method of improving perception integrity as described above. For example, in other embodiments one of the sensors is an infrared camera. An advantage provided by an infrared camera is that resulting images tend not to be significantly affected by the presence of smoke clouds.

In the above embodiments there are two heterogeneous sensors (the laser scanner and the camera). However, in other embodiments there are more than two sensors, including at least two heterogeneous sensors.

In the above embodiments, the laser scan of the vehicles surroundings (determined from data from the laser scanner) is affected by the presence of the dust cloud (i.e. the laser scanner measures range values from the vehicle to the dust cloud as opposed to range values from the vehicle to the obstacles). However, in other embodiments the laser scan is affected by a different entity, for example smoke, cloud, or fog. Furthermore, the process may also be used advantageously in situations in which there are no dust clouds etc.

In the above embodiments, the likelihood of correspondence of laser and camera data is determined by identifying laser corner points and matching edges in the camera image. However, in other embodiments different features of the respective images may be used. For example, in other embodiments other points of a laser segment (i.e. points not corresponding to corners) are used. In such embodiments, an inference process may need to be used in addition to the above described method steps in order to accurately check the consistency of the laser/camera images.

In the above embodiments, a probability value is determined to indicate the probability that a certain laser corner point corresponds to a matched edge in the camera image. However, in other embodiments a different appropriate metric indicative of the extent to which a certain laser corner point corresponds to a matched edge in the camera image is used.

In the above embodiments, a decision about whether or not the laser scan and the camera image correspond to one another is dependent on probability values that certain laser corner points correspond to respective matched edges in the camera image. However, in other embodiments this decision is based upon different appropriate criteria.

Apparatus, including the processor, for performing the method steps described above, may be provided by an apparatus having components on the vehicle, external to the vehicle, or by an apparatus having some components on the vehicle and others remote from the vehicle. Also, the apparatus may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A method of processing sensor data, the method comprising:
measuring a value of a first parameter of a scene using a first sensor to produce a first image of the scene;
measuring a value of a second parameter of the scene using a second sensor to produce a second image of the scene;
identifying a first point, the first point being a point of the first image that corresponds to a class of features of the scene;
identifying a second point, the second point being a point of the second image that corresponds to the class of features;
projecting the second point onto the first image;
determining a similarity value between the first point and the projection of the second point on to the first image; and
comparing the determined similarity value to a predetermined threshold value.

2. A method according to claim 1, wherein the similarity value is a value related to a distance in the first image between the first point and the projection of the second point on to the first image.

3. A method according to claim 1, the method further comprising:
defining a neighbourhood in the second image around the second point; and
projecting the neighbourhood onto the first image; wherein
the step of identifying the first point comprises identifying the first point such that the first point lies within the projection of the neighbourhood onto the first image.

4. A method according to claim 3, wherein the step of determining a value related to a distance comprises:
defining a probability distribution mask over the projection of the neighbourhood in the first image, the probability distribution mask being centred on the projection of the second point on the first image; and
determining a value of the probability distribution mask at the first point.

5. A method according to claim 1, wherein the first parameter is different to the second parameter.

6. A method according to claim 1, wherein the first sensor is a different type of sensor to the second sensor.

7. A method according to claim 6, wherein the first parameter is light intensity, the first sensor type is a camera, the second parameter is range, and the second sensor type is a laser scanner.

8. A method according to claim 1, the method further comprising calibrating the second image of the scene with respect to the first image of the scene.

9. A method according to claim 8, wherein the step of calibrating the second image of the scene with respect to the first image of the scene comprises determining a transformation to project points in the second image to corresponding points in the first image.

10. A method according to claim 9, wherein a step of projecting is performed using the determined transformation.

11. A method according to claim 1, wherein the similarity value is a value of a probability that the second image corresponds to the first image.

12. A method according to claim 3, wherein the similarity value is a value of a probability that the second image corresponds to the first image and where the probability is calculated using the following formula:
$$P ( A \vert B , C ) = η \frac{P ( C \vert A , B ) P ( B \vert A ) P ( A )}{P ( B )}$$
where: A is the event that the second image corresponds to the first image;
B is the event that the first point lies within the projection of the neighbourhood onto the first image;
C is the projection of the second point onto the first image; and
η is a normalisation factor.

13. Apparatus for processing sensor data, the apparatus comprising:
a first sensor for measuring a value of a first parameter of a scene to produce a first image of the scene;
a second sensor for measuring a value of a second parameter of the scene to produce a second image of the scene; and
one or more processors arranged to:
identify a first point, the first point being a point of the first image that corresponds to a class of features of the scene;
identify a second point, the second point being a point of the second image that corresponds to the class of features;
project the second point onto the first image;
determine a similarity value between the first point and the projection of the second point on to the first image; and
compare the determined similarity value to a predetermined threshold value.

14. An apparatus according to claim 13, wherein the similarity value is a value related to a distance in the first image between the first point and the projection of the second point on to the first image.

15. An autonomous vehicle comprising the apparatus of claim 13.

16. A computer program or plurality of computer programs arranged such that when executed by a computer system it/they cause the computer system to operate in accordance with the method of claim 1.

17. A machine readable storage medium storing a computer program or at least one of the plurality of computer programs according to claim 16.
